(19) United States
(12) Patent Application Publication
(10) Pub. No.: US 2018/0020772 A1
(43) Pub. Date: Jan. 25, 2018

(54) COMPOSITE ORTHOTIC DEVICE

(71) Applicant: VIONIC GROUP LLC, San Rafael, CA (US)

(72) Inventor: Terence Mitchell, Larkspur, CA (US)

(21) Appl. No.: 15/215,392

(22) Filed: Jul. 20, 2016

(51) Int. Cl. A43B 17/02; B29D 35/12; A43B 7/14; A43B 17/00; A43B 7/32

(52) U.S. Cl. CPC A43B 17/02; A43B 17/003; A43B 7/32; A43B 7/14; B29D 35/122; B29K 2023/083

(57) ABSTRACT

A composite orthotic device for use with footwear includes a resiliently deformable base part and a resiliently deformable upper part, forming a plurality of foot supporting portions of differing durometer adapted to guide the wearer's foot along a Center of Pressure path from heel strike to toe-off to follow a biomechanically corrected gait path.

### FIELD OF INVENTION

This invention relates to a composite orthotic device particularly suitable as an insole for use inside an article of footwear, or for integration into an article of footwear or an article of orthopaedic footwear such as the midsole and/or outsole of a sandal, shoe, boot or other type of footwear. The invention also relates to a method of moulding an orthotic device to a user's foot.

### BACKGROUND TO THE PRESENT INVENTION

So called “orthotic devices” are known, ranging from simple contoured insoles to costly structures integrally incorporated into made-to-order orthopaedic footwear. Orthotic devices which can be inserted into an article of footwear to provide cushioning for a user's foot are generally known. Orthotic devices which can be inserted into an article of footwear to provide improved support for a user's foot and control the user's gait are also generally known.

Attempts have been made to provide an orthotic device which offers a combination of cushioning and foot motion control. One such example is PCT publication number WO2007/021328 in the name of Spenco Medical Corporation which describes an insole said to provide both improved cushioning and control of foot motion. The solution presented in the application is to provide a device including a foam core, a semi-rigid stability cradle, and a number of elastomeric pods and pads which can be affixed to the device. The characteristics of the components, their size and shape, and their position are said to be selectable to provide a desired blend of cushioning and control, and more specifically to achieve a desired biomechanical function.

European patent no 0500652 describes a contoured, mouldable orthotic device of about three-quarters the length of the boot or shoe in which it is to fit, having an integrally-formed heel cup, a longitudinal arch “raise”, a metatarsal “raise” and a varus post. It also describes a method for the subsequential in situ moulding, to a patient's foot, of the mouldable orthotic device, in which the device is placed in the boot or shoe as far back as it will go and then heated. The patient's foot is then introduced into the boot or shoe and the now-pliable orthotic device is moulded and otherwise manipulated to the foot.

The inventor has appreciated that known orthotic devices have attempted to provide a combination of cushioning and foot motion control through the use of pads or wedges of varying densities which can be applied to the external surface of the device. However, this only provides a localised affect on the user's gait path. The previously presented solutions do not therefore provide optimum biomechanical control of the user's gait over the entire ground contact phase of the user's gait cycle from heel strike to toe-off.

A number of theories of the biomechanical function of the foot have been put forward during the last 50 years. The inventor has appreciated that footwear or insole products based on a singular theory are unable to capture the true function of the foot, leg and upper body. The inventor has also appreciated that, although there are differences in their theories, the many academics studying this field have agreed on a number of common principles and that there is a need for an improved orthotic device that functions in accordance with these agreed principles and provides optimum biomechanical control of the user's gait over the entire ground contact phase of the user's gait cycle from heel strike to toe-off.

### SUMMARY OF THE INVENTION

The invention, in a first aspect, provides a composite orthotic device for use inside, or as part of, an article of footwear, which defines a foot-engaging surface for contacting a user's foot and a ground-engaging surface for contacting the inside of a user's shoe or the ground. The composite orthotic device comprises a resiliently deformable base part defining the ground-engaging surface, and a resiliently deformable upper part defining the foot-engaging surface, wherein: the base part is generally harder than the upper part; the base part and the upper part are attached to one another to form the composite orthotic device; the composite orthotic device has a greater rigidity than the respective individual base and upper parts; in use of the composite orthotic device, the base part provides support for a user's foot and the upper part provides cushioning and support for the user's foot; and, the base part and the upper part cooperate in use of the composite orthotic device so as to cause the user's foot to follow a natural, flowing, path during a ground contact phase of the user's gait cycle.

The composite orthotic device of the present invention includes upper and base parts which operate synergistically in use of the device to provide more effective cushioning and support for the user's foot throughout the ground contact phase of the user's gait cycle. The orthotic device allows the user to have a more normal, biomechanically accepted stance and to follow a more normal, biomechanically accepted gait path from heel strike to toe-off. The device allows the entire surface of the user's foot to flow through the certain directions by means of a series of externally applied, substantially stiff, wedges or pads as in prior art orthotic devices.

Preferably, in the use of the orthotic device, the base part and the upper part cooperate so as to cause a user's ground contact phase of the gait cycle from heel strike to toe-off to be substantially aligned with an accepted preferred or ideal gait path. The ideal gait path is diagrammatically illustrated in FIGS. 17 and 17A.

In one aspect of the invention, the composite orthotic device comprises a resiliently deformable base part for engaging an inside of a wearer's shoe on the ground, and a resiliently deformable upper part for supporting a wearer's foot when the footwear is worn, the base part comprising a plurality of portions of differing durometer adapted to guide the wearer's foot along a Center of Pressure path during the ground contact phase of the wearer's gait cycle. The base part is harder and stiffer than said upper part to provide support for the user's foot, and said upper part is softer and less stiff than said base part to provide cushioning for a user's foot. The composite orthotic device is harder and stiffer than said base part or upper part individually; and the base part and the upper part cooperate to support a wearer's ground contact from heel strike to toe-off to follow a biomechanically correct gait path.

In one aspect the composite orthotic device substantially conforms to a sole of a user's foot.

In another aspect the base part is preformed with a contoured shape in an unloaded condition, said contoured shape having variable, pre-determined angles and thicknesses. In such aspect the base part preferably is preformed with an integrally molded heel cup, a longitudinal arch raise, and a raised lateral portion positionable adjacent the Calcaneal Cuboid and the 4^{th} and 5^{th} metatarsals of the user's foot.

In another aspect the base part includes: a lateral heel strike support portion, a medial heel strike support portion, a Calcaneal Cuboid support portion, a medial longitudinal arch support portion, a distal lateral forefoot support portion, a first metatarsal support portion for the second, third, and fourth metatarsal heads, a second metatarsal support portion for the first metatarsal head, and a forefoot extension support portion. In such aspect the support portions preferably have Shore C hardness values ordered from hardest to softest as follows:

first metatarsal support portion,

distal lateral forefoot support portion,

medial longitudinal arch support portion,

calcaneal cuboid support portion,

medial heel strike support portion,

lateral heel strike support portion,

forefoot extension support portion, and

second metatarsal support portion.

In such aspect the Shore C hardness values of the composite orthotic device preferably are about:

74 to 85 for the first metatarsal support portion,

69 to 80 for the distal lateral forefoot support portion,

67 to 78 for the medial longitudinal arch support portion,

64 to 72 for the calcaneal cuboid support portion,

58 to 67 for the medial heel strike support portion,

56 to 63 for the lateral heel strike support portion,

40 for the forefoot extension support portion, and

20 for the second metatarsal support portion.

In another aspect the upper part is preformed to have a contoured shape in an unloaded condition, said contoured shape having variable, pre-determined angles and thicknesses.

In still yet another the upper part is preformed with an integrally molded heel cup, a longitudinal arch raise, a raised lateral portion positionable adjacent the calcaneal cuboid and the 4^{th} and 5^{th} metatarsals, and an overhang portion which overhangs a base part in the region of the device that is adapted to underlie the metatarsals of the wearer's foot.

In another aspect a shock-absorbing insert is provided in the heel cup portion of the base part so as to cushion that area of the wearer's foot and/or a shock-absorbing insert is provided at a portion of the device adapted to underlie the metatarsals of the wearer's foot so as to cushion that area of the wearer's foot. In such aspect the shock-absorbing insert preferably extends at least partially through a full thickness of the device. Preferably, the base part and/or the upper part are made from Ethyl Vinyl Acetate foam.

In a particularly preferred embodiment, the base part is pressed from a blank of Ethyl Vinyl Acetate foam of about 11 mm thickness and the upper part is pressed from a blank of Rebound Ethyl Vinyl Acetate foam of about 18 mm thickness.

In another and preferred aspect, a length of the orthotic device is substantially three-quarters of a length of an article of footwear, so as to underlie the heel bone and terminate proximate the head ends of the metatarsal of the wearer's foot, the base part preferably is pressed from a blank of Ethyl Vinyl Acetate material of about 11 mm thickness and the upper part is pressed from a blank of Rebound Ethyl Vinyl Acetate material of about 18 mm thickness, and the upper part preferably is sheathed in a fabric-like outer skin such as a layer of nylon fabric treated with an antibacterial and/or anti-microbial agent.

In yet another aspect, the composite orthotic device is moldable to the shape of the wearer's foot by the application of heat, the upper and base parts are attached to one another by an adhesive, preferably an adhesive having a higher melting point than the temperature required to mold the composite orthotic device to the shape of a user's foot, and the device is moldable to the shape of the wearer's foot by heating a lower surface of the composite orthotic device to soften and shape the material.

The present invention also provides a method of moulding a composite orthotic device to a wearer's foot, comprising the steps of:

(i) providing a composite orthotic device as above described;

(ii) periodically applying warm air to said composite orthotic device until said composite orthotic device reaches a temperature of approximately 90 degrees Centigrade;

(iii) fitting said composite orthotic device to an article of footwear;

(iv) fitting the article of footwear to a wearer's foot, with the wearer seated;

(v) palpating the wearer's subtalar joint to a neutral position;

(vi) with the wearer standing, putting equal weight on each foot while maintaining the neutral position of the said subtalar joint, pressing medial and lateral edges of said article of footwear inwards so as to contour the composite orthotic device into the wearer's neutral foot position;

(vii) allowing the device to cool to ambient air temperature; and

(viii) optionally including the step of adding at least one of a pad, wedging, posting, or a shock-absorbing insert to the composite orthotic device to customize the device for the wearer.

Preferably, the device has a variable foot-engaging surface profile designed to compliment the profile of the sole of a user's foot and has variable hardness at different points on the foot-engaging surface profile adapted to underlie different parts of the user's foot so as to provide, in use, a combination of support and cushioning for a user's foot from heel strike and toe-off which assists in guiding and controlling the user's gait path

Preferably, the base part is preformed to have a contoured shape with variable, pre-determined angles and thicknesses in an unloaded condition. More preferably, the base part is preformed with an integrally moulded heel cup, a longitudinal arch raise and a raised lateral portion positionable adjacent to the calcaneal cuboid and the 4^{th}/5^{th} metatarsals of the user's foot as described below in connection with a discussion of FIG. 6.

As depicted in FIG. 9, the base part preferably includes: a lateral heel strike portion (H1), a medial heel strike portion (H2), a Calcaneal Cuboid portion (M1), a medial longitudinal arch portion (M2), a distal lateral forefoot section (FF1), a first metatarsal portion for the second, third and fourth metatarsal heads (FF2), a second metatarsal portion for the first metatarsal head (FF3) and a forefoot extension portion (FF4). Preferably, the medial heel strike portion (H2) is relatively harder than the lateral heel strike portion (H1); the Calcaneal Cuboid portion (M1) is relatively harder than the lateral heel strike portion (H1) and the medial heel strike portion (H2); the medial longitudinal arch portion (M2) is relatively harder than the lateral heel strike portion (H1), the medial heel strike portion (H2) and the Calcaneal Cuboid portion (M1); the distal lateral forefoot section (FF1) is relatively harder than the lateral heel strike portion (H1), the medial heel strike portion (H2), the Calcaneal Cuboid portion (M1) and the medial longitudinal arch portion (M2); the first metatarsal portion (FF2) is relatively harder than the lateral heel strike portion (H1), the medial heel strike portion (H2), the Calcaneal Cuboid portion (M1), the medial longitudinal arch portion (M2) and the distal lateral forefoot section (FF1); the second metatarsal portion (FF3) is relatively softer than the lateral heel strike portion (H1), the medial heel strike portion (H2), the Calcaneal Cuboid portion (M1), the medial longitudinal arch portion (M2), the distal lateral forefoot section (FF1) and the first metatarsal portion (FF2); and the fore foot extension portion (FF4) is relatively softer than the lateral heel strike portion (H1), the medial heel strike portion (H2), the Calcaneal Cuboid portion (M1), the medial longitudinal arch portion (M2), the distal lateral forefoot section (FF1) and the first metatarsal portion FF2 but relatively harder than the second metatarsal portion FF3. This construction of the base part provides an improved composite orthotic device which more effectively guides and supports the user's foot through the ground contact phase of gait cycle, substantially aligning the gait path with a predetermined gait path. Preferably, the Shore hardness values of the composite orthotic device are within certain specified ranges. More preferably, the Shore hardness values are as set out in Table 1 below.

Preferably, the upper part is preformed such that it has a contoured shape having variable, pre-determined angles and thicknesses in an unloaded condition. More preferably, the upper part is preformed with an integrally moulded heel cup, a longitudinal arch raise, a raised lateral portion positionable adjacent the calcaneal cuboid and the 4^{th}/5^{th} metatarsals and an overhang portion which overhangs the base part in the region of the device that is adapted to underlie the metatarsals of a user's foot.

One or more sponge-like, shock-absorbing inserts may be attached to the heel cup portion of the ground engaging surface of the base part so as to cushion that area of the user's foot in use of the device. One or more sponge-like, shock-absorbing inserts may also be attached to the metatarsal portion of the ground engaging surface of the top part so as to cushion that area of the user's foot in use of the device. This assists in facilitating 1^{st} Ray plantarflexion. Preferably, each shock-absorbing insert extends at least partially through the full thickness of the orthotic device. This helps to minimise the need for any localised increase in the thickness of the device.

Preferably, the upper and base parts are made from Ethylene Vinyl Acetate (“EVA”). More preferably, the upper part is made from rebound EVA having a higher rebound characteristic and improved shock attenuation compared to the base part. In a full length version of the device the base part and the upper parts are pressed from a blank of EVA material about 11 mm thick. In a three-quarter length version of the device, preferably, the base part is pressed from a blank of EVA material about 11 mm thick and the upper part is pressed from a blank of EVA material about 18 mm thick.

Preferably, the foot-engaging surface of said device is sheathed in a fabric-like outer skin. More preferably, the fabric-like outer skin is a layer of nylon fabric treated with antibacterial and/or anti microbial agent.

Preferably, the composite orthotic device is mouldable to the shape of a user's foot by the application of heat. Preferably, the base and upper parts are attached to one another by an adhesive. Preferably, the adhesive has a higher melting point than the temperature required to mould the composite orthotic device to the shape of a user's foot. More preferably, the composite orthotic device is mouldable to the shape of a user's foot by heating the lower (plantar) surface to a temperature of about 90 degrees Centigrade. This ensures that the adhesive does not degrade when the composite device is heated.

The invention in a second aspect provides: a method of moulding a composite orthotic device to a user's foot. The method of moulding the device allows the composite device to be tailored to a particular user for improved support and control of the foot. The method may be used to mould a device to one or both of the user's feet as required. Where a pair of devices are required by a user, the method is preferably used to mould one device at a time.

### BRIEF DESCRIPTION OF THE DRAWINGS

The structure, operation and advantages of presently preferred embodiments of the present invention will now be further described, by way of example only, with reference to the accompanying figures, in which like numerals depict like parts, and wherein:

FIG. 1 is a top view of a full length version of a composite orthotic device embodying the present invention;

FIG. 2 is a bottom view of the full length version of the composite orthotic device of FIG. 1;

FIG. 3 is a top view of a three-quarter length version of a composite orthotic device embodying the present invention;

FIG. 4 is a bottom view of the three-quarter length version of the composite orthotic device of FIG. 3;

FIG. 5 is perspective view from above of the full length composite orthotic device of FIGS. 1 and 2;

FIG. 6 is an exploded perspective view from above of the full length composite orthotic device of FIGS. 1 and 2;

FIG. 7 is a perspective view from below of the full length composite orthotic device of FIGS. 1 and 2;

FIG. 8 is an exploded perspective view from below of the full length composite orthotic device of FIGS. 1 and 2;

FIG. 9 is the view of FIG. 2 showing various regions or portions of the device designed to underlie different parts of a user's foot;

FIG. 10 shows a cross section through the heel cup portion at the Sustentaculum Tali Control (STC) point on a section through area H2 of FIG. 9;

FIG. 11 shows a sagittal plane cross-section view through a midfoot region of the composite orthotic device of FIGS. 1 and 2 at area M2 of FIG. 9;

FIG. 12 shows a cross-section through the composite orthotic device of FIGS. 1 and 2 at area FF2 of FIG. 9;

FIG. 13 shows a cross-section through the orthotic device of FIGS. 1 and 2 at point M1/M2 (FIG. 9);

FIG. 14 depicts a side view of the orthotic device of FIGS. 1 and 2 showing the medial arch profile of the orthotic device;

FIG. 15 illustrates another side view of the orthotic device of FIG. 1 showing the lateral profile of the orthotic device;

FIG. 16 shows the view of FIG. 2 with additional shock absorbing plugs and a thermal indicator line;

FIG. 17 is the view of FIG. 2 showing on the underside of the device a generally accepted ‘ideal’ flow path of the Centre of Pressure during the contact phase of the human gait cycle;

FIG. 17A shows the path of the Centre of Pressure on the planter surface of the foot aligned with the timing percentages of the contact phases of the human gait cycle;

FIG. 17B graphically illustrates stance and swing phases of a human gait cycle;

FIG. 18 is a perspective view of the medial aspect of the human foot, depicting the Calcaneus, Sustentaculum Tali, Navicular Tuberosity, Cuboid, Calcaneal Cuboid joint, midtarsal coalition, Cuneiforms, 1^{st} to 5^{th} Metatarsals and Hallux;

FIGS. 19A and 19B are photographic illustrations of palpitation of the Talonavicular joint; and

FIG. 20 is a block diagram of the method of moulding the orthotic device of this invention to the user's foot.

### DETAILED DESCRIPTION OF PREFERRED EMBODIMENTS

The following description relates to a composite orthotic device 1, which may be inserted into an article of footwear. However, the composite orthotic device may also be used as the midsole or outsole portion, or part of the midsole or outsole portion, of an article of footwear or an article of orthotic footwear.

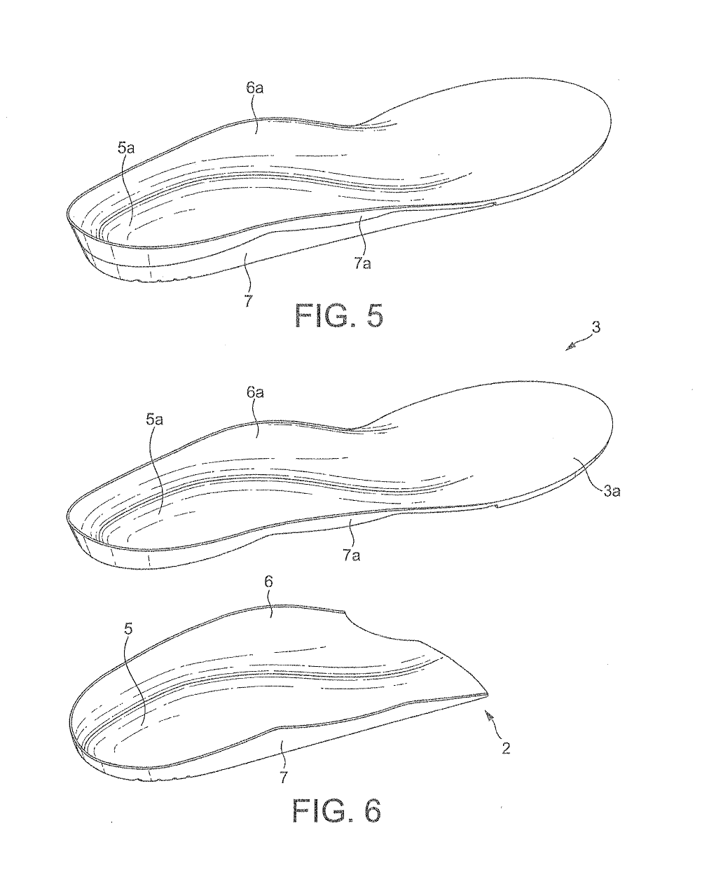

With reference to FIGS. 1-8, an orthotic device embodying the present invention comprises a base part 2 and a upper part 3 which are connected to one another by adhesive, moulding or other suitable means of attachment. As described further below, the adhesive preferably has a melting point higher than about 90 degrees Centigrade to prevent melting or degradation of the adhesive during heating of the orthotic device when moulding it to a user's foot. Preferably the upper part 3 and base part 2 are substantially permanently attached by the adhesive so that the upper and base part form a composite or laminate orthotic device in which the upper and base parts operate in conjunction with one another as the device accommodates movement of a user's foot.

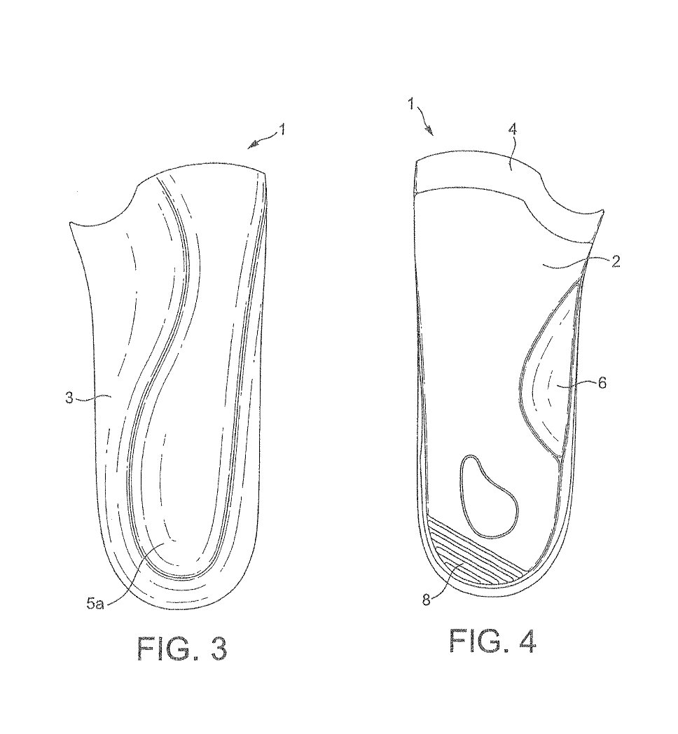

The orthotic device may be provided in a three-quarter length version (FIGS. 3 and 4) which substantially underlies the user's foot from the calcaneus portion to a point proximal of the metatarsal portion and a full-length version (FIGS. 1, 2 and 5 to 8) which substantially underlies the whole of a user's foot. This makes the orthotic design compatible with a multitude of footwear styles for both men's and women's footwear from business or casual styles for the three quarter length model to leisure or sporting applications of the full length model.

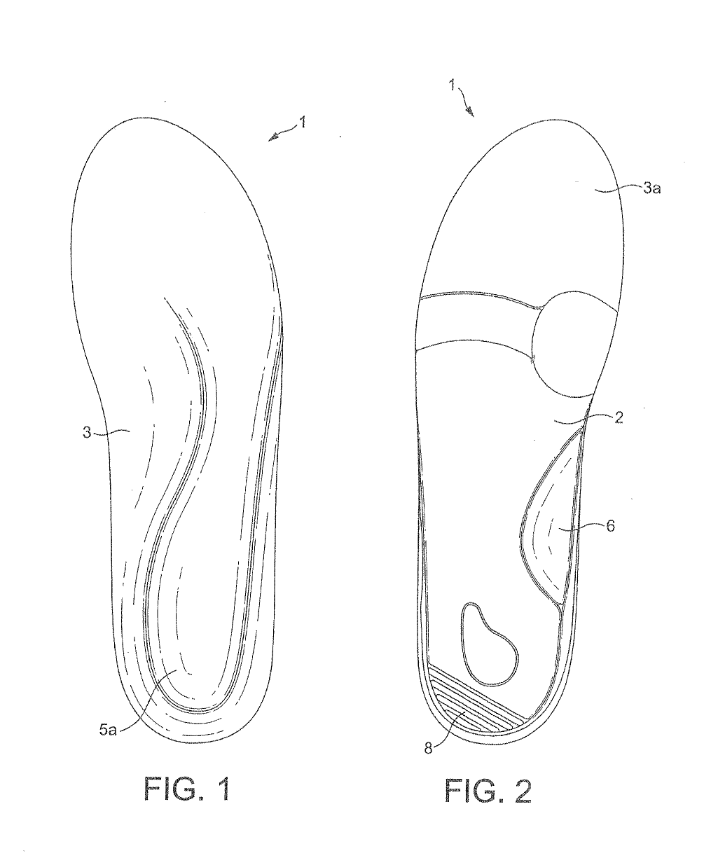

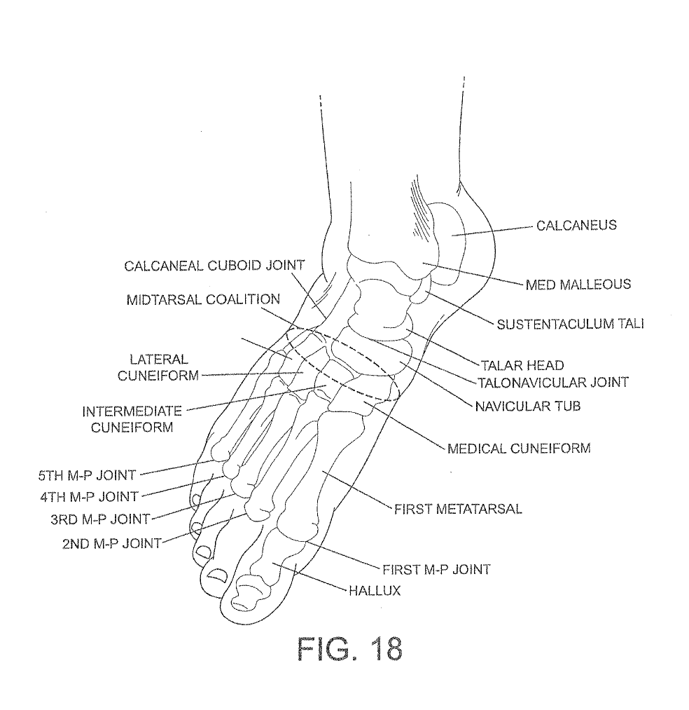

In the full length version of the device, the upper part 3 is full length and underlies the whole of the patient's foot and the base part 2 underlies the user's foot from the calcaneus through to the proximal aspect of the 1st to 5th metatarsal phalangeal (MP) joints. See FIG. 18. The upper part 3 overlies the whole of the base part 2 and extends beyond the base part 2, the upper part 3 being the only part underlying the foot in a forefoot extension region 3a (FIG. 2). The upper surface of the upper part 3 forms a foot-engaging surface. The lower surface of the base part 2 and the lower surface of the upper part 3 in the forefoot extension region 3a form a ground or footwear engaging surface.

In the three-quarter length device, the upper part 3 may be the same length as, but is preferably slightly longer than, the base part 2 so that a portion 4 of the upper part overhangs the distal end of the base part 2. This provides greater cushioning of the metatarsal portion of the foot and helps to locate the base and upper parts 2, 3. The following description generally relates to both types of device unless otherwise stated.

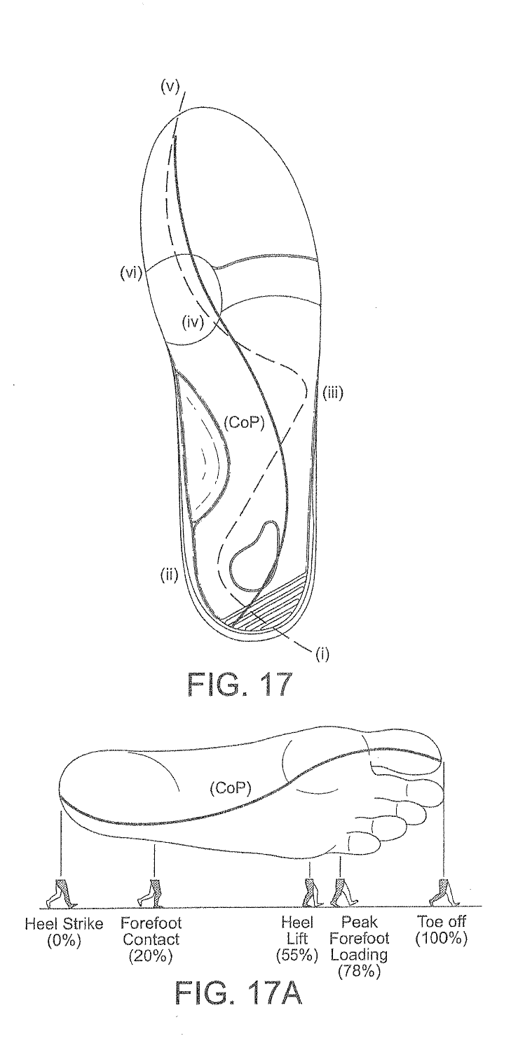

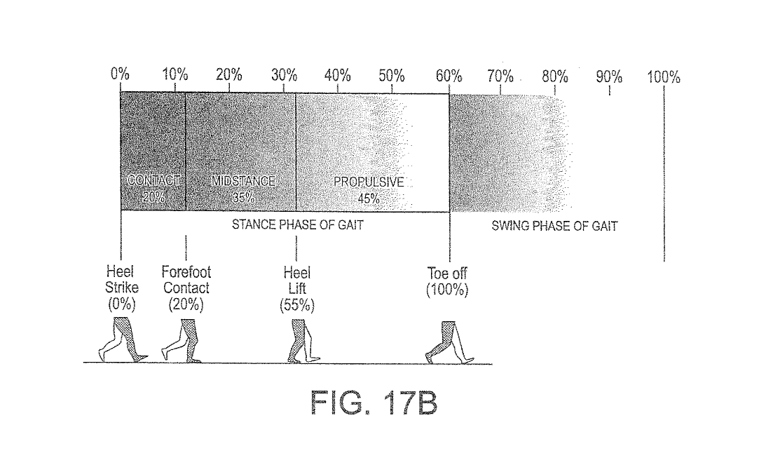

The base part 2 is pre-formed with an integrally moulded heel cup 5 for locating the calcaneus, a longitudinal arch raise 6 for providing support to the medial arch, and a raised lateral portion 7 at the calcaneal cuboid and 4th/5th metatarsals. See FIG. 18. The heel cup 5, arch raise 6 and raised lateral portion 7 collectively increase ground reaction forces across the lateral forefoot region and lock the mid tarsal region of the foot thereby enhancing gait function by providing a rigid lever effect during the propulsive phase of the human gait cycle in which there is a transition from mid stance through to heel up and toe-off. See FIG. 17B. The heel cup 5 may include a series of projections or ribs 8 which provide some shock absorption on heel strike and help to prevent movement of the orthotic device relative to a shoe.

The upper part 3 is also pre-formed with an integrally moulded heel cup 5a, a longitudinal arch raise 6a for providing support to the medial arch, and a raised lateral portion 7a at the calcaneal cuboid and 4^{th}/5^{th} metatarsals. These features of the upper part 3 are designed to overlie and substantially match the shape of the base part 2 to provide a large area of contact between the base and upper parts 2, 3 and to locate the base 2 and upper part 3 relative to one another.

In the combined orthotic device, the base part 2, which, as discussed in more detail below, is relatively harder than the upper part, provides orthotic control to facilitate the agreed principles of lower limb biomechanical function. The upper part 3, which has a hardness less than the base part 2, not only provides orthotic control for the foot but since it is more compressible than the base part 2 it provides cushioning upon impact with the user's foot. The base part 2 and the upper part 3 are preformed to have a variable profile over the width and length of these parts. The base part 2 and upper part 3 are combined to form a composite orthotic device having a profile which generally conforms to the shape of a user's foot in which varying intrinsic angles and hardness values at various points over the profile of the device, which are positioned under different parts of the user's foot in use of the device, assist with control of the user's gait. The combined device acts to bring the user's Centre of Pressure substantially closer to and substantially into alignment with the Centre of Pressure of an ideal human gait path from heel strike to toe off See FIGS. 17 and 17A.

The inherent contours and profile of the preformed base part 2 and upper part 3 combine to provide an orthotic device having variable thickness and hardness across the surface of the device in the unloaded condition prior to use. The combined contours also create intrinsic, variable angulations across the device which assist in guiding the foot through the accepted, biomechanically correct, flow path of the human gait cycle from heel strike (contact phase—shock absorber) through mid-stance (stable platform) and on to the propulsive (rigid lever) phase for optimum foot function as described below in connection with a discussion of FIG. 17 and FIG. 17B.

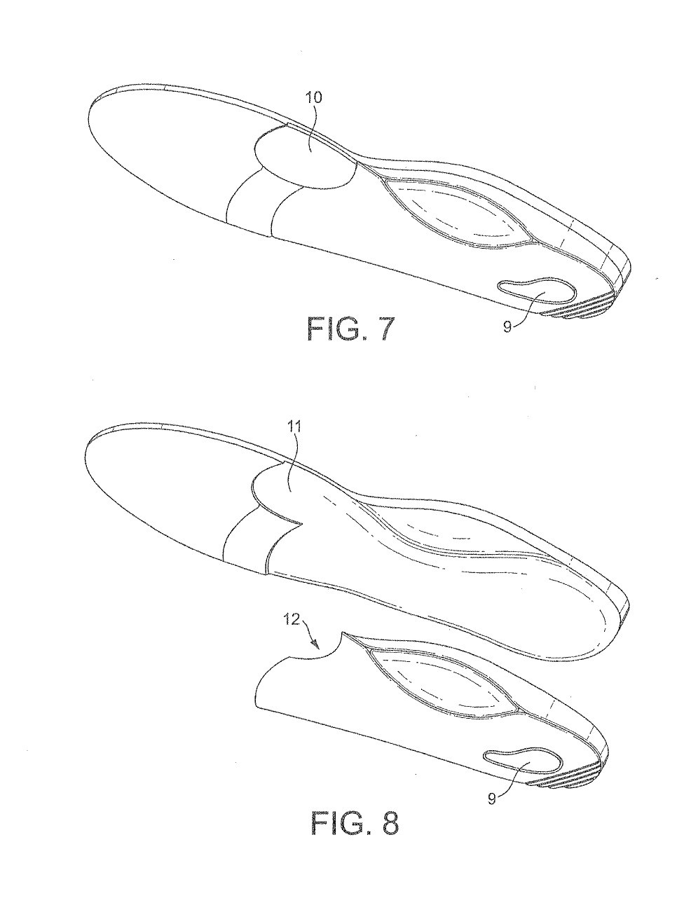

With reference to FIGS. 7, 8 and 16, in a modification, the orthotic device may incorporate one or more sponge-like, shock-absorbing inserts, postings or wedges 9, preferably made of low-density polyurethane foam, adapted to cushion that area immediately beneath the calcaneus. Such an insert 9 may aptly be termed a “shock dot” or “shock spot”. In the full-length variant, a further shock-absorbing insert 10 may be positioned in the region of the device which underlies the first metatarsal to improve the function of the composite device, including providing additional cushioning for that part of the user's foot during use. During manufacture of the composite device, shock absorbing insert 9 may be attached to the base part 2 and shock-absorbing insert 10 may be attached to the underside of the upper part 3 by an adhesive compound. As shown in FIGS. 7 and 8, the insert 10 may extend partially through the full thickness of the orthotic device in a recess 11 in the underside of a forefoot extension portion 3a of the upper part 3. The insert may be positioned within a cutaway portion 12 of the base part 2 so that it is attached only to the underside of the upper part 3. In the three-quarter length version, shock-absorbing insert 9 may be used but shock-absorbing insert 10 is typically not required.

In a further modification, the upper or “foot-engaging” surface of the upper part 3 of the composite orthotic device may be covered, or sheathed, with a fabric-like outer “skin” which may be a layer of brushed nylon fabric 13 attached to the foot-engaging surface by an adhesive. The fabric layer 13 may be treated with antibacterial and/or anti microbial agent.

The base part 2 may be manufactured from open-cell EVA foam such as is commonly utilised in footwear midsoles and in orthotic manufacture. Whilst other materials including closed cell EVA foam, polyurethane, polyethylene, thermoplastic polyurethane etc., may be applicable to this construction, the versatility of an open cell EVA foam is considered to have superior moldability, flexibility and light weight characteristics. The upper part 3 is also preferably manufactured from EVA foam, and more preferably Rebound EVA foam having a pre-formed Shore C hardness rating which is about 30% less than the shore hardness of the EVA materials from which the base part 2 is made. This gives the upper part 3 a higher rebound characteristic and improved shock attenuation compared to the base part 2.

The base part 2 and the upper part 3 are heat and pressure moulded from blanks of EVA foam. In the three quarter length version, the blanks for each of the base part 2 and the upper part 3 are preferably about 11 mm thick. In the full-length version, the blanks for each of the base part 2 and the upper part 3 are preferably about 11 mm and about 18 mm thick, respectively.

In a further modification, one or more wedges or inserts (not shown) may be used to customise the orthotic device. These may be attached to the underside of the base part 2, inserted into grooves, slots, channels, holes in the base part 2 of the device or otherwise applied to vary the position of the device in an article of footwear.

The human gait cycle is a very complicated coordinated series of movements. Walking is divided up into two main phases. The contact phase is the weight bearing portion of each gait cycle, followed by the swing phase where the foot is off of the ground. The contact phase is initiated at heel contact and ends with the toes leaving the ground of the same foot. Swing phase is initiated with toe off and ends with heel contact of the same foot. See FIGS. 17A and 17B.

In normal gait, the foot strikes the ground at the beginning of the contact phase in a supinated position of approximately 2°. The foot moves through 5½° to 6° of pronation, passing through the neutral position, to a position of approximately 3½° to 4° pronated which allows the foot to function as a mobile adaptor, adjusting to variances in terrain. At 3½° to 4° pronation, the beginning of the mid-stance phase occurs. The foot begins to re-supinate and passes through neutral position, at which time the foot begins the propulsive phase continuing in supination through toe-off.

FIGS. 17 and 17A show the “ideal” path of the center of pressure (CoP) on the plantar surface of the foot as it moves in the contact phase of gait. “Center of pressure” in this context is the term given to the integrated pressure field that the human body exerts on a supporting surface via the foot. The generally accepted ideal or desired location of the CoP changes during the contact phase of gait, and is depicted by the solid line 20 shown in FIG. 17. The variable densities and intrinsic angles of the orthotic device of this invention, described below, guide the foot during each part of the contact phase of gait, namely, (i) heel strike, (ii) the initial phase of pronation, (iii) re-supination during mid-stance, (iv) plantarflexion of the 1st ray and Hallux dorsiflexion, and, (v) toe off, as shown in dotted lines in FIGS. 17 and 17A. This enables the foot to follow a natural, flowing path that substantially approximates the ideal path of the CoP during the contact phase of the human gait cycle.

The following description refers to example values of the hardness of the material from which the base part 2 and the upper part 3 are made and the hardness at various points on the plantar and dorsal surfaces of the composite orthotic device. The hardness values are Shore C hardness values measured using a known type of Shore durometer, in this instance, a Type C durometer with bull-nose measurement tip marketed by Teclock: 2-10-3 Naruta-cho Okaya-shi NaganoPref. 394-0042 Japan. The hardness was measured in the unloaded condition of the orthotic device prior to use by applying the measurement tip to various points on the combined orthotic device in order to measure the resistance of the material to a given force applied at the measurement tip by the durometer.

The following description also refers to example values of the intrinsic angles in the profile of the foot-engaging surface of the composite orthotic device. These values are angular values in degrees and are measured in the unloaded condition of the orthotic device prior to use of the device to support a user/wearer.

The following description also refers to example values of the thickness of the composite orthotic device at various points over the width and length of the device. These values are the combined thickness, in millimetres, of the orthotic device consisting of the base part 2 and the upper part 3 and are measured in the unloaded condition of the orthotic device prior to use of the device to support a user/wearer.

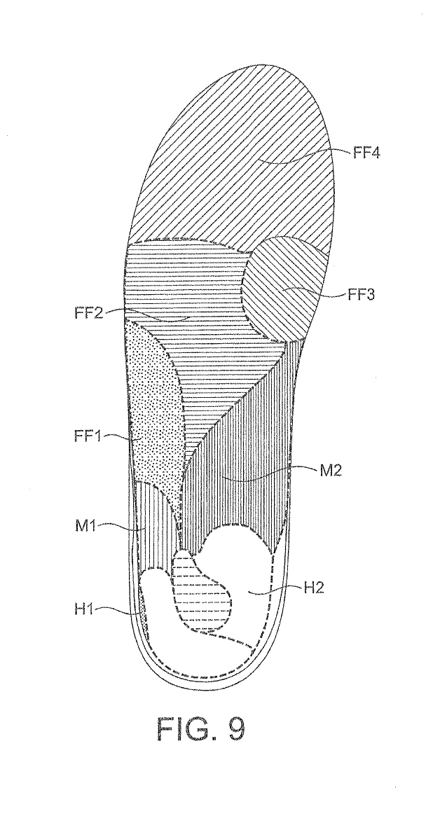

With reference to FIG. 9, the base part 2 is divided into a number of regions or areas including: a lateral heel strike portion (H1); a medial heel strike portion (H2); a Calcaneal Cuboid portion (M1), a medial longitudinal arch portion (M2); a distal lateral forefoot section (FF1); and a first metatarsal portion for the second, third and fourth metatarsal heads (FF2). In the three-quarter length version of the device, the upper part also has regions H1, H2, M1, M2, FF1 and FF2 which are generally superimposed over the corresponding regions of the base part. In the full length version of the device, the upper part similarly has regions H1, H2, M1, M2, FF1 and FF2 which are generally superimposed over the corresponding regions of the base part and the upper part is also provided with forefoot extension portion FF4. When the optional shock absorbing insert 10 is added to the composite device, the composite device also has a second metatarsal portion for the first metatarsal head (FF3). It should be understood that all the areas noted above, as depicted in FIG. 9, are for purposes of illustration only and are approximate due to manufacturing and material tolerances.

The base part 2 and upper part 3 are formed by pressing and shaping blanks of EVA foam and combined to form the combined orthotic device, in which: the medial heel strike portion (H2) has a hardness greater than the hardness of the lateral heel strike portion (H1); the Calcaneal Cuboid portion (M1) is relatively harder than the lateral heel strike portion (H1) and the medial heel strike portion (H2); the medial longitudinal arch portion (M2) is relatively harder than the lateral heel strike portion (H1), the medial heel strike portion (H2) and the Calcaneal Cuboid portion (M1); the distal lateral forefoot section (FF1) is relatively harder than the lateral heel strike portion (H1), the medial heel strike portion (H2), the Calcaneal Cuboid portion (M1) and the medial longitudinal arch portion (M2); the first metatarsal portion (FF2) is relatively harder than the lateral heel strike portion (H1), the medial heel strike portion (H2), the Calcaneal Cuboid portion (M1), the medial longitudinal arch portion (M2) and the distal lateral forefoot section (FF1); the second metatarsal portion (FF3) has a hardness which is less than that of the lateral heel strike portion (H1), the medial heel strike portion (H2), the Calcaneal Cuboid portion (M1), the medial longitudinal arch portion (M2), the distal lateral forefoot section (FF1) and the first metatarsal portion (FF2), and the fore foot extension portion FF4 has a hardness which is less than that of lateral heel strike portion (H1), the medial heel strike portion (H2), the Calcaneal Cuboid portion (M1), the medial longitudinal arch portion (M2), the distal lateral forefoot section (FF1) and the first metatarsal portion FF2, but relatively harder than the second metatarsal portion FF3.

Table 1 below provides approximate Shore C hardness values of the base part 2 of the orthotic device, made from EVA foam, as measured in an unloaded condition. It should be noted that such hardness values may vary if other materials, such as those discussed above, are used to fabricate the base part 2.

TABLE 1
Approximate Shore C values of the base part
of the orthotic device in an unloaded Condition

| Portion of orthotic device | Approximate Shore C value range |
|---|---|
| Lateral heel strike portion (H1) | 56 to 63 |
| Medial heel strike portion (H2) | 58 to 67 |
| Calcaneal Cuboid portion (M1), | 64 to 72 |
| Medial longitudinal arch portion | 67 to 78 |
| (M2), | |
| A distal lateral forefoot section | 69 to 80 |
| (FF1), | |
| First metatarsal portion for the | 74 to 85 |
| second, third and fourth metatarsal | |
| heads (FF2) | |
| Second metatarsal portion for the | 20 |
| first metatarsal head (FF3) | |
| (where included in the full length | |
| version) | |
| Fore Foot extension portion (FF4) | 40 |

Table 1A below provides example approximate Shore C hardness values of the upper part 3 of the orthotic device, made from Rebound EVA foam, as measured in an unloaded condition.

TABLE 1A
Approximate Shore C values of the upper part
of the orthotic device in an unloaded condition.

| | APPROXIMATE |
|---|---|
| PORTION OF ORTHOTIC DEVICE | SHORE C VALUE |
| Lateral heel strike portion (H1) | 45 |
| Medial heel strike portion (H2) | 45 |
| Calcaneal Cuboid portion (M1), | 45 |
| Medial longitudinal arch portion (M2), | 47 |
| A distal lateral forefoot section (FF1), | 50 |
| First metatarsal portion for the second, third | 47 |
| and fourth metatarsal heads (FF2) | |
| Second metatarsal portion for the first | 45 |
| metatarsal head (FF3) (where included in the | |
| full length version) | |
| Fore Foot extension portion (FF4) | 40 |

Table 2 below provides approximate values of the intrinsic angles of the foot-engaging surface of the composite orthotic device in the unloaded condition prior to use of the device to support a user:

TABLE 2
Approximate angle in degrees of foot-engaging surface of composite
orthotic device in the unloaded condition prior to use

| Portion of orthotic device | Approximate angle in degrees |
|---|---|
| Lateral heel strike portion (H1) | 0 |
| Medial heel strike portion (H2) | 6-20 |
| Calcaneal Cuboid portion (M1), | 40 |
| Medial longitudinal arch portion | 30 |
| (M2), | |
| A distal lateral forefoot section | 10 |
| (FF1), | |
| First metatarsal portion for the | 10 |
| second, third and fourth metatarsal | |
| heads (FF2) | |
| Second metatarsal portion for the | 0 |
| first metatarsal head (FF3) (where | |
| included in the full length version) | |
| Fore Foot extension portion (FF4) | 0 |

Referring to FIG. 9, in use of the combined orthotic device the lateral heel strike portion H1 is the point of heel impact on the lateral rear quadrant of the orthotic. The relatively lower hardness value of about Shore C 56-63 assists in attenuating the impact shock. A lateral heel “Grid” in the form of a series of projecting ribs 8 assists in preventing shear forces in the footwear that may otherwise cause the orthotic to move relative to the footwear.

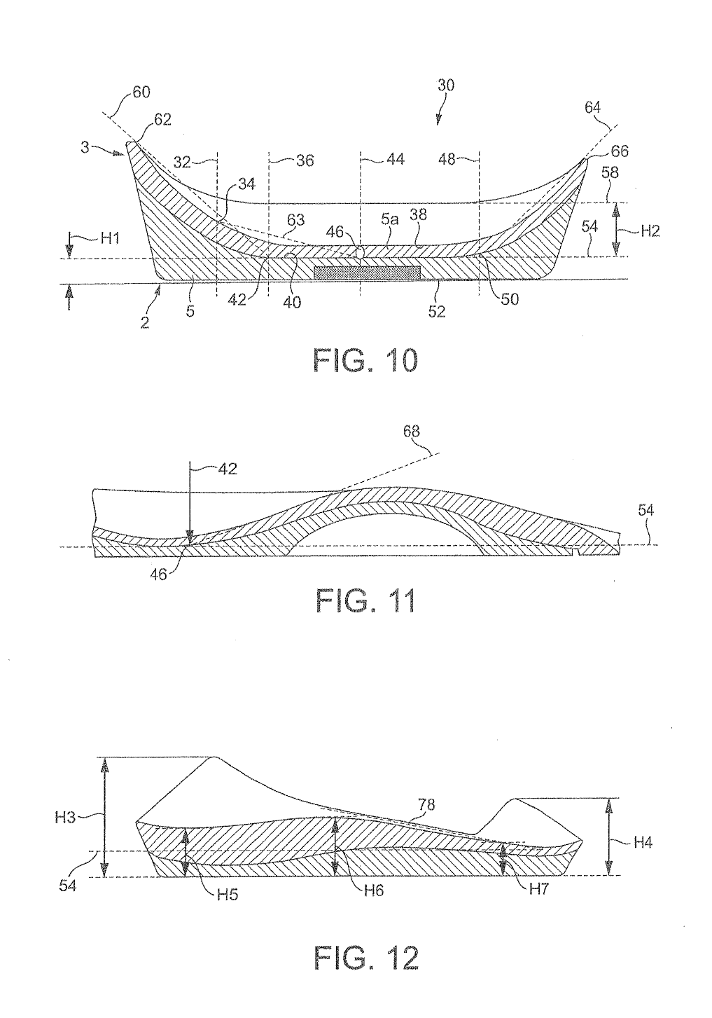

As the foot pronates and rolls medially the higher Shore C hardness of about 58-67 of the combined base and upper parts and the intrinsic medial heel cup angulations, described below in connection with a discussion of FIG. 10, assists in preventing over-pronation by resisting calcaneal eversion.

As the body moves from behind to over the foot via ankle dorsiflexion, the standing foot re-supinates as the swing leg externally rotates the hip. The foot then moves laterally into mid-stance assisted by the intrinsic angulations and varying hardness of the combined orthotic device. The combined Shore C hardnesses and intrinsic angulations at the Calcaneal Cuboid portion M1, and the medial longitudinal arch portion M2, assist in increasing the ground reaction forces to the mid tarsal joint stabilizing the mid foot. See FIG. 9.

During midstance the foot should continue to re-supinate and converts from a shock attenuator into a stable platform. As the body passes in front of the foot via continued ankle dorsiflexion (elevation), the orthotic device of this invention assists in providing a path of least resistance via its intrinsic fore foot angulations and variable hardnesses at the distal lateral forefoot section FF1, the first metatarsal portion for the second, third and fourth metatarsal heads FF2, and the second metatarsal portion to the first metatarsal head FF3. See FIG. 9. This promotes 1st ray plantarfiexion (downward movement) facilitating Hallux dorsiflexion (elevation), which, in turn, instigates the Windlass Mechanism tightening the plantar facial band, a primary facilitator of midtarsal joint stabilization. See discussion of FIG. 12 below. The variable shore hardnesses and thicknesses (see FIGS. 12-1st, 2nd & 3rd and 5th metatarsal heights) in the fore foot region of the orthotic device in areas FF1, FF2 and FF3 (FIG. 9) assist in this function. In particular, the intrinsic metatarsal raise 6 in the device (FIG. 6, 2nd/3rd metatarsal), in association with the lower hardness of the rebound EVA insert 10 in the area FF3 (about Shore C 20 hardness) compared to the area FF3, assists in the plantarflexion of the 1st metatarsal. These functional aspects of the foot are imperative for a correct and efficient execution of the Sagittal Plane Facilitation (propulsive) phase of human gait.

FIG. 10 is a cross sectional view through the medial heel strike portion H2 (FIG. 9) showing a combined heel cup 30 at the Sustentaculum Tali Control (STC) point 34 of the orthotic device. As described above, the base part 2 is formed with a moulded heel cup 5 and the upper part 3 is formed with a moulded heel cup 5a. For purposes of the present discussion, the orthotic device of this invention is considered to comprise a combination of the base part 2 and upper part 3 which collectively form a combined heel cup 30. With reference to FIG. 18, the Sustentaculum Tali is universally accepted as the point where the rear foot control of a foot orthotic is focussed in controlling. The sustentaculum tali is a facet of the calcaneus, or heel hone. Also known as the talar shelf, it is found on the medial side of the calcaneus, the same side of the foot as the big toe. The sustentaculum tali forms a joint with a portion of the talus, a bone of the ankle, and is an insertion point for three ankle ligaments: the plantar calcaneonavicular ligament, the tibiocalcaneal ligament, and the medial talocalcaneal ligament. As it projects from the main bone mass at a 90-degree angle, it is important as a weight-bearing structure. Pressure can be exerted with good compliance from the patient at the “STO” which directly supports the Talus.

As illustrated in FIG. 10, a number of vertical axes are depicted for the purpose of identifying intrinsic angles of the orthotic device. The vertical axis 32 intersects the STC control point 34 of the orthotic device. The STC control point 34 is the medial control point for the rear foot and is an essential element of a foot orthotic in controlling rear foot Frontal plane range of motion. It exerts an anti pronatory force on the calcaneus during the pronatory phase of gait. This force is dependent on the shore hardness of the EVA material and the intrinsic angulations of the medial heel cup and the weight and rate of motion (walking-running) of the wearer. The vertical axis 36 intersects the medial side of the bottom surface 38 of upper part 3, at its juncture with the top surface 40 of base part 2, defining a point 42. The vertical axis 44 intersects the centre of the combined heel cup 30, and defines a point 46 at the juncture of the bottom surface 38 of upper part 3 and the top surface 40 of base part 2. The vertical axis 48 intersects the lateral side of the bottom surface 38 of upper part 3, at its juncture with the top surface 40 of base part 2, defining a point 50. The height H1 of the heel cup 5 of base part 2 at the centre of the combined heel cup 30 is preferably about 3 mm (unloaded), measured between the bottom surface 52 of the heel cup 5 and a horizontal axis 54 extending along the intersection of the bottom surface 38 of the upper part 3 and the top surface 40 of the base part 2. The height H2 of the combined heel cup 30 is about 15 mm (unloaded), measured from the horizontal axis 54 and the dorsal surface 58 of the combined heel cup 30. It is essential for stabilizing the calcaneus during the contact phase of human gait.

The combined base part 2 and upper part 3 create a number of intrinsic angles in the orthotic device of this invention. A medial angle of about 20° (unloaded) is formed by a line 60 which extends tangent to a point 62 at the medial top edge of the combined heel cup 30 and passes through the STC control point 34, as measured relative to the horizontal axis 54. An angle of about 6° (unloaded) is formed by a line 63 extending between the STC control point 34 and the point 46 at the centre of the combined heel cup 30, as measured relative to the horizontal axis 54. The intrinsic angle of the lateral side heel cup is about 30°, and it is defined by a line 64 which extends tangent to a point 66 at the lateral top edge of the combined heel cup 30 and passes through point 50, as measured relative to the horizontal axis 54.

FIG. 11 shows a sagittal plane cross-section view of midfoot region of the combined orthotic device at M2. The vertical axis 42, the point 46 and the horizontal axis 54 described above in connection with a discussion of FIG. 10 are shown in FIG. 11. An angle of about 30° (unloaded) is formed by a line 68 drawn as a tangent from point 46 along the proximal arch in the sagittal plane, measured relative to the horizontal axis 54.

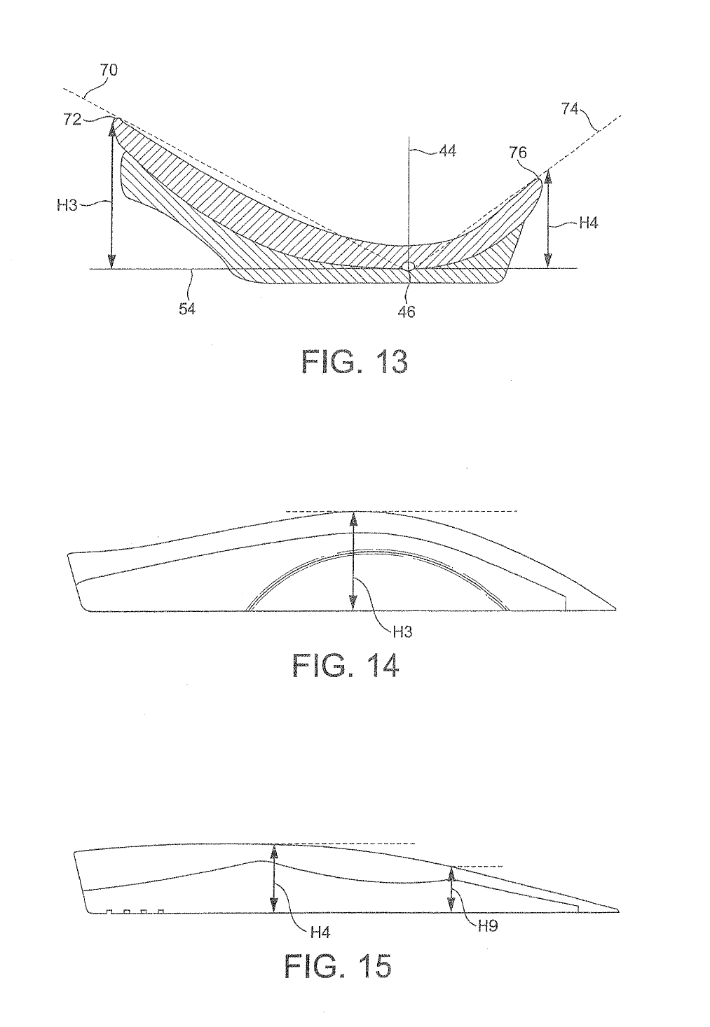

FIG. 12 is a cross-sectional view distal to proximal of the fore foot region of the orthotic device in the area FF2, and FIG. 13 is a cross-sectional view proximal of the fore foot region of the orthotic device in the area M2. See FIG. 9. The medial arch height H3 is about 26 mm (unloaded) at its peak with an intrinsic angle of about 30° formed by a line 70 drawn as a tangent from a point 72 at the peak of the medial arch to the point 46 at which the vertical axis 44 intersects the centre of the combined orthotic device 30. The height H4 of the lateral arch border is about 20 mm (unloaded). An intrinsic angle of about 40° is formed by a line 74 drawn as a tangent from a point 76 at the peak of the lateral arch border to the point 46 at which the vertical axis 44 intersects the centre of the combined orthotic device 30. Such intrinsic angles are measured between the lines 70, 74 and horizontal axis 54.

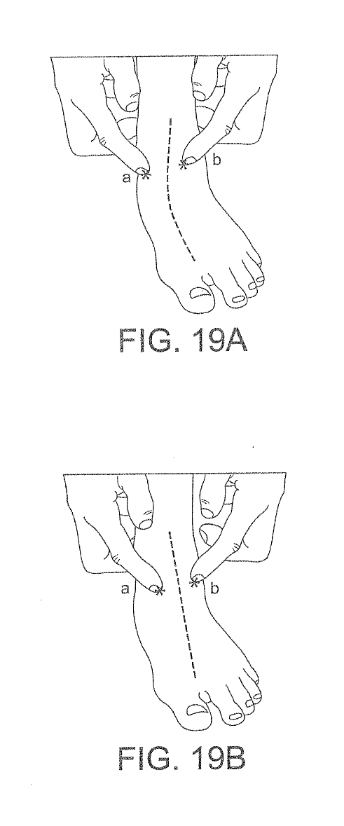

As shown in FIG. 12, the metatarsal support in the area FF2 runs from the 1st metatarsal with a height H5 of about 11 mm (unloaded), laterally across the 2nd/3rd metatarsals to a height H6 of about 13 mm (unloaded), and, on to the 4th/5th metatarsals at a height H7 of about 7 mm (unloaded). This metatarsal raise forms a lateral intrinsic angle of about 10° which is defined by a line 78 drawn tangent to the peak height of the metatarsal raise which intersects horizontal axis 54 in the area of the 5th metatarsal. The metatarsal raise assists in promoting the fore foot transverse arch and facilitates 1st Ray plantarflexion. Plantarflexion of the first metatarsal is essential for a correct and efficient gait. It is the primary instigator of the well-known “Windlass Mechanism” that assists in tightening the plantar fascia and re-supinating the foot during the propulsive phase of gait. See FIG. 17B. If the foot is in a pronated position (FIG. 19A) as the foot enters the propulsive phase of gait, ground reaction forces will dorsiflex (elevate) the 1st metatarsal blocking the function of the Hallux by restricting its ability to bend (dorsiflex). By ensuring the foot is around its neutral position (FIG. 19B) and further encouraging the first metatarsal to plantarfiex (drop) via the softer material directly below the first MP joint (See FIG. 9, area FF3), the Hallux is positioned to function correctly. This is achieved in the orthotic device of this invention with the combined Sagittal and Transverse angulations, and the variable hardnesses of areas FF2 and FF3, as described above.

FIG. 14 shows the medial arch profile of the orthotic device. The medial arch peak height H3 is about 26 mm (unloaded). The medial arch position is designed to enhance rear foot medial control with the control point of the orthotic device more proximally positioned and shorter in length than conventional orthotics. This also ensures the distal medial edge of the orthotic device finishes proximal to the 1^{st} metatarsal when the orthotic device is correctly sized. This is essential to assist function of the 1st ray when plantarflexing in the propulsive phase of human gait.

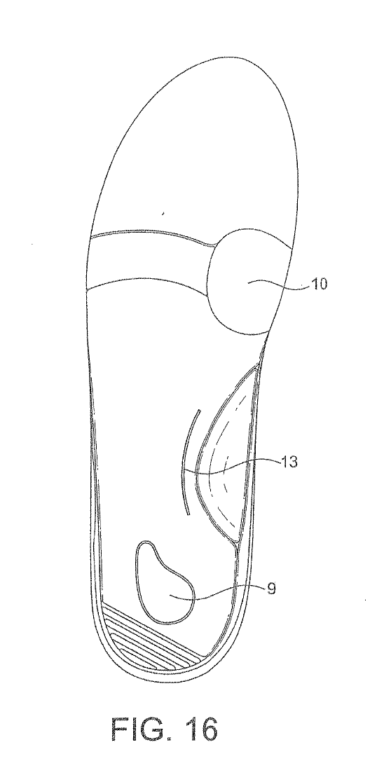

FIG. 15 shows the lateral arch profile of the orthotic device. Of note is the increased height H4 (about 20 mm) of the combined orthotic device compared to known devices to increase ground reaction forces at the point of the Calcaneal Cuboid joint, where height H4 is measured, and at the 4th/5th metatarsals where the peak height of the lateral point at the 5th metatarsal, H8, is measured (about 12 mm). These features of the profile of the orthotic device assist in stabilizing the foot in the Mid Stance phase of the human gait cycle.

FIG. 16 shows the plantar aspect of the full length orthotic device. A shock attenuator or plug 9 of rebound EVA foam having a hardness of about Shore C 20 in the mid-heel section helps to attenuate vertical force under the calcaneus during heel strike. The optional additional low hardness plug 10 of rebound EVA foam having a hardness of about Shore C 20 enhances the function of the 1st ray as it plantarfiexes allowing the Hallux to dorsiflexes in the propulsive phase of human gait. It provides a path of lower resistance compared to the higher hardness rebound EVA in the forefoot extension and the higher hardness EVA at the distal edge of the base part 2. FIG. 16 also depicts a thermal indicator 13 which assists in the correct heating of the plantar surface of the orthotic during a moulding process discussed below.

FIG. 18 shows the medial aspect of the human foot, in particular the references to the Calcaneus, Sustentaculum Tali, Navicular Tuberosity, Cuboid, 1st Metatarsal and Hallux, which are all key points of measurement, function and control in the human foot.

A method of customising the composite orthotic device described above will now be described.

During manufacture, the composite orthotic device is customisable according to a number of factors, including the height, weight, gait and athletic ability and demands of the user. The base part 2 is selectable from a range of preformed, contoured, base parts, each having different Shore C hardness values from the other base parts in the range. For example, the range of base parts may include three base parts: (i) a low hardness base part of about Shore C 55 to 60 (post production); (ii) a medium hardness base part of about Shore C 65 to 70 (post production); and (iii) high hardness of about Shore C 75 to 80 (post production). These Shore C values are post production of the base part 2, before the orthotic device is moulded to a patient's foot as discussed below.

Table 3 below provides example approximate Shore C hardness values of the range of standard base parts 2 which may be selected to form a customised orthotic device:

TABLE 3
Example approximate Shore C hardness values
of the range of a range standard base parts

| | Low | | High |
|---|---|---|---|
| | Hardness | Medium | Hardness |
| | Base Part | Hardness | Base Part |
| | Approximate | Base Part | Approximate |
| Portion of orthotic | Shore | Approximate | Shore |
| device | C value | Shore C value | C value |
| Lateral heel strike portion | 56 | 60 | 63 |
| (H1) | | | |
| Medial heel strike portion | 58 | 63 | 67 |
| (H2) | | | |
| Calcaneal Cuboid portion | 64 | 68 | 72 |
| (M1), | | | |
| Medial longitudinal arch | 67 | 71 | 78 |
| portion (M2), | | | |
| A distal lateral forefoot | 69 | 74 | 80 |
| section (FF1), | | | |
| First metatarsal portion for | 74 | 78 | 85 |
| the second, third and | | | |
| fourth metatarsal heads | | | |
| (FF2) | | | |

The selected base part 2 is preferably attached during manufacture to a standard upper part 3 by an adhesive to form the composite orthotic device. The adhesive compound used to join the base and upper parts preferably has a relatively high melting point (preferably above 90 degrees Centigrade) to avoid melting of the adhesive during moulding of the orthotic device.

Additionally, one or more of any of shock attenuators, wedges, inserts or shock absorbing inserts as previously described may be added to the combined orthotic device to customise the device and control the position of the device and the users foot relative to an article of footwear.

After the composite orthotic device has been assembled, the device is then mouldable to a particular user's foot using a moulding process that will now be described.

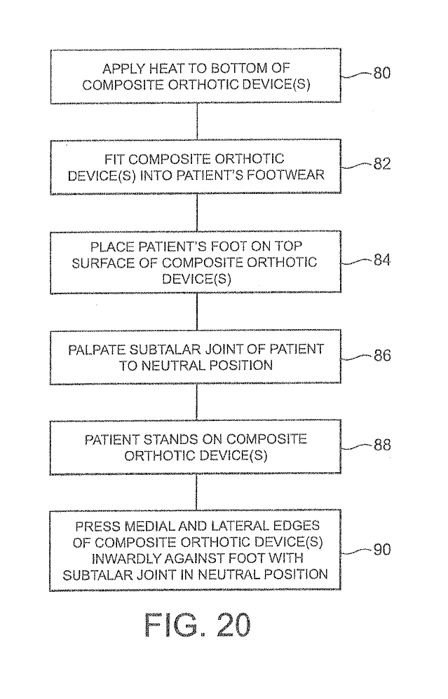

With reference to the block diagram shown in FIG. 20, a suitable moulding process proceeds as follows. A composite orthotic device formed in accordance with the present invention (or two such devices where required for each of the user's feet) is placed on a heat resistant surface with the base part 2 facing upwards. The orthotic device is then heated with a stream of hot air, from a suitable source, using a sequence cycle of about five seconds “on” followed by about five seconds “off. The heat source is moved in a wavy motion back and forth over the device at a distance of about 4-6” along a thermal indicator line 13 on the base of the orthotic device. See block 80 of FIG. 20 and FIG. 16. When the thermal indicator line 13 has disappeared, the orthotic device is ready for moulding.

The heating cycle is repeated until such time as the orthotic device has undergone a total heating time of about twenty to thirty seconds and the thermal indicator line 13 has faded away. The heated orthotic device is fitted into the user's footwear (not shown), indicated at block 82. The patient is then seated and his or her foot is placed onto the upper surface of the orthotic device (block 84), at which time the subtalar joint is palpated (block 86), in the known manner, to the neutral position. See FIGS. 19A and 19B.

This process is repeated for each foot individually where a composite orthotic device is required for each foot. The patient is then required to stand (block 88), putting equal weight on each foot, while maintaining the neutral position of the subtalar joint. The medial and lateral edges of the article of footwear are pressed inwards so as to contour the warm mouldable orthotic device to the patient's neutral foot position. See block 90. One, or each, orthotic device is removed from the footwear and is left to cool for a period of about five minutes. Once cool, the, or each, moulded composite device is inserted into the user's footwear and is ready for use.

The same method may be used when an orthotic device is to be moulded to each of a patient's feet. Both articles of footwear of the pair should be worn to ensure equal balance during the moulding of each device.

If required, additional postings/wedges may be applied to the plantar distal orthotic device's edge subsequent to the moulding process. Moreover, it will be realised that the composite mouldable orthotic device may be easily re-moulded if the desired result is not initially attained.

While the invention has been described with reference to a preferred embodiment, it should be understood by those skilled in the art that various changes may be made and equivalents may be substituted for elements thereof without departing from the scope of the invention. In addition, many modifications may be made to adapt a particular situation or material to the teachings of this invention without departing from the essential scope thereof. For example, while the composite orthotic device has been described particularly for use as an insole inside an article of footwear, as mentioned above, the composite orthotic device may form the midsole and/or outsole of a sandal, shoe, boot or other type of footwear. Therefore, it is intended that the invention not be limited to the particular embodiment disclosed as the best mode contemplated for carrying out this invention, but that the invention will include all embodiments falling within the scope of the appended claims.

What is claimed:

1. A composite orthotic device for use with an article of footwear, comprising:
a resiliently deformable base part for engaging an inside of a wearer's shoe on the ground, and a resiliently deformable upper part for supporting a wearer's foot when the footwear is worn, the base part comprising a plurality of portions of differing durometer adapted to guide the wearer's foot along a Center of Pressure path during the ground contact phase of the wearer's gait cycle;
wherein said base part is harder and stiffer than said upper part to provide support for the user's foot, and said upper part is softer and less stiff than said base part to provide cushioning for a user's foot;
wherein said composite orthotic device is harder and stiffer than said base part or upper part individually; and
wherein the base part and the upper part cooperate to support a wearer's ground contact from heel strike to toe-off to follow a biomechanically correct gait path.

2. The composite orthotic device according to claim 1, wherein the composite orthotic device substantially conforms to a sole of a user's foot.

3. The composite orthotic device according to claim 1, wherein the base part is preformed with have a contoured shape in an unloaded condition, said contoured shape having variable, pre-determined angles and thicknesses.

4. The composite orthotic device according to claim 3, wherein the base part is preformed with an integrally molded heel cup, a longitudinal arch raise, and a raised lateral portion positionable adjacent the Calcaneal Cuboid and the 4^{th} and 5^{th} metatarsals of the user's foot.

5. The composite orthotic device according to claim 1, wherein the base part includes: a lateral heel strike support portion, a medial heel strike support portion, a Calcaneal Cuboid support portion, a medial longitudinal arch support portion, a distal lateral forefoot support portion, a first metatarsal support portion for the second, third, and fourth metatarsal heads, a second metatarsal support portion for the first metatarsal head, and a forefoot extension support portion.

6. The composite orthotic device according to claim 6, wherein said support portions have Shore C hardness values ordered from hardest to softest as follows:
first metatarsal support portion,
distal lateral forefoot support portion,
medial longitudinal arch support portion,
calcaneal cuboid support portion,
medial heel strike support portion,
lateral heel strike support portion,
forefoot extension support portion, and
second metatarsal support portion.

7. A composite orthotic device according to claim 7, wherein the Shore C hardness values of the composite orthotic device are about:
74 to 85 for the first metatarsal support portion,
69 to 80 for the distal lateral forefoot support portion,
67 to 78 for the medial longitudinal arch support portion,
64 to 72 for the calcaneal cuboid support portion,
58 to 67 for the medial heel strike support portion,
56 to 63 for the lateral heel strike support portion,
40 for the forefoot extension support portion, and
20 for the second metatarsal support portion.

8. The composite orthotic device according to claim 1, wherein the upper part is preformed to have a contoured shape in an unloaded condition, said contoured shape having variable, pre-determined angles and thicknesses.

9. The composite orthotic device according to claim 1, wherein the upper part is preformed with an integrally molded heel cup, a longitudinal arch raise, a raised lateral portion positionable adjacent the calcaneal cuboid and the 4^{th} and 5^{th} metatarsals, and an overhang portion which overhangs a base part in the region of the device that is adapted to underlie the metatarsals of the wearer's foot.

10. The composite orthotic device according to claim 1, wherein a shock-absorbing insert is provided in the heel cup portion of the base part so as to cushion that area of the wearer's foot.

11. The composite orthotic device according to claim 1, wherein a shock-absorbing insert is provided at a portion of the device adapted to underlie the metatarsals of the wearer's foot so as to cushion that area of the wearer's foot.

12. The composite orthotic device according to claim 10, wherein the shock-absorbing insert extends at least partially through a full thickness of the device.

13. The composite orthotic device according claim 1 wherein the base part is made from Ethyl Vinyl Acetate foam.

14. The composite orthotic device according to the claim 12, wherein the shock-absorbing insert extends at least partially through a full thickness of the device.

15. The composite orthotic device according to claim 1, wherein the upper part is made from Ethyl Vinyl Acetate foam.

16. The composite orthotic device according to claim 15, wherein the upper part is made from Rebound Ethyl Vinyl Acetate foam.

17. The composite orthotic device according to claim 1, wherein the base part is pressed from a blank of Ethyl Vinyl Acetate foam of about 11 mm thickness and the upper part is pressed from a blank of Rebound Ethyl Vinyl Acetate foam of about 11 mm thickness.

18. The composite orthotic device according to claim 1, wherein a length of the orthotic device is substantially three-quarters of a length of an article of footwear, so as to underlie the heel bone and terminate proximate the head ends of the metatarsal of the wearer's foot.

19. The composite orthotic device according to claim 18 wherein the base part is pressed from a blank of Ethyl Vinyl Acetate material of about 11 mm thickness and the upper part is pressed from a blank of Rebound Ethyl Vinyl Acetate material of about 18 mm thickness.

20. The composite orthotic device according to claim 1, wherein the upper part is sheathed in a fabric-like outer skin.

21. The composite orthotic device according to claim 20, wherein the fabric-like outer skin is a layer of nylon fabric treated with an antibacterial and/or anti-microbial agent.

22. The composite orthotic device according to claim 1, wherein the composite orthotic device is moldable to the shape of the wearer's foot by the application of heat.

23. The composite orthotic device according to claim 1, wherein the upper and base parts are attached to one another by an adhesive.

24. The composite orthotic device according to claim 23, wherein the adhesive is an adhesive having a higher melting point than the temperature required to mold the composite orthotic device to the shape of a user's foot.

25. The composite orthotic device according to claim 22, wherein the device is moldable to the shape of the wearer's foot by heating a lower surface of the composite orthotic device to soften an shape the material.

26. A method of moulding a composite orthotic device to a wearer's foot, comprising the steps of:
(i) providing a composite orthotic device as claimed in claim 1;
(ii) periodically applying warm air to said composite orthotic device until said composite orthotic device reaches a temperature of approximately 90 degrees Centigrade;
(iii) fitting said composite orthotic device to an article of footwear;
(iv) fitting the article of footwear to a wearer's foot, with the wearer seated;
(v) palpating the wearer's subtalar joint to a neutral position;
(vi) with the wearer standing, putting equal weight on each foot while maintaining the neutral position of the said subtalar joint, pressing medial and lateral edges of said article of footwear inwards so as to contour the composite orthotic device into the wearer's neutral foot position; and
(vii) allowing the device to cool to ambient air temperature.

27. The method of moulding a composite orthotic device according to claim 26 further including the step of adding at least one of a pad, wedging, posting, or a shock-absorbing insert to the composite orthotic device to customize the device for the wearer.

28. The composite orthotic device according to claim 11, wherein the shock-absorbing insert extends at least partially through a full thickness of the device.
